(19) United States
(12) Patent Application Publication
(10) Pub. No.: US 2009/0071015 A1
(43) Pub. Date: Mar. 19, 2009

(54) BLADE CLAMP MECHANISM

(76) Inventor: John S. Scott, Brookfield, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/209,908

(22) Filed: Sep. 12, 2008

Related U.S. Application Data
(60) Provisional application No. 60/972,577, filed on Sep. 14, 2007.

(51) Int. Cl. B23D 51/08

(52) U.S. Cl. 30/339

(57) ABSTRACT

A cutting tool clamp mechanism for a power tool includes a housing supported on a spindle, the spindle being configured to drive a cutting tool. A locking member is positioned in and movable with respect to the housing, the locking member including a slot extending through the locking member for receiving the cutting tool, the slot defined by at least one surface for engaging the cutting tool when the cutting tool is received by the slot. A biasing member is configured for applying a force to the locking member to bias the at least one surface of the locking member into engagement with the cutting tool when the cutting tool is received by the slot. The locking member is movable between an engaged condition, in which the slot receives the cutting tool into the housing in a first direction and the at least one surface of the locking member is engageable with the cutting tool to resist movement of the cutting tool in a second direction opposite the first direction, and a released condition, in which the locking member moves against the force of the biasing member and the at least one surface of the locking member is disengageable from the cutting tool.

### CROSS-REFERENCE TO RELATED APPLICATION(S)

This application claims priority to U.S. Provisional Patent Application No. 60/972,577, entitled “BLADE CLAMP MECHANISM”, filed Sep. 14, 2007 by John S. Scott, the entire contents of which is hereby incorporated by reference.

### BACKGROUND

The present invention relates to reciprocating saws and more specifically to a blade clamp mechanism for quickly and easily replacing and securing a saw blade to a spindle of a reciprocating saw.

Hand held reciprocating tools, such as electric reciprocating saws, include removable blades, which permit the use of different cutting edges as may be necessary for cutting different materials and for the replacement of worn or damaged blades. This requires a blade mounting system that allows rapid blade replacement while accurately and firmly coupling the blade to the tool. Typically, blade mounting systems require a tool, such as an Allen wrench or a special key, in order to replace and secure the blade, which is a slow and often difficult process.

### SUMMARY

The invention provides a cutting tool clamp mechanism. The cutting tool clamp mechanism includes a housing supported on a spindle, the spindle being configured to drive a cutting tool. A locking member is positioned in and movable with respect to the housing, and the locking member includes a slot extending through the locking member for receiving the cutting tool, the slot defined by at least one surface for engaging the cutting tool when the cutting tool is received by the slot. A biasing member is configured for applying a force to the locking member to bias the at least one surface of the locking member into engagement with the cutting tool when the cutting tool is received by the slot. The locking member is movable between an engaged condition, in which the slot receives the cutting tool into the housing in a first direction and the at least one surface of the locking member is engageable with the cutting tool to resist movement of the cutting tool in a second direction opposite the first direction, and a released condition, in which the locking member moves against the force of the biasing member and the at least one surface of the locking member is disengageable from the cutting tool.

The invention further provides a cutting tool clamp mechanism for a power tool. The cutting tool clamp mechanism includes a housing supported on a spindle, the housing being configured to receive a cutting tool in an insertion pathway and the spindle being configured to drive the cutting tool. A first slot extends through the housing and receives the cutting tool, the first slot configured for guiding the cutting tool along the insertion pathway and the first slot defined by at least one surface for engaging the cutting tool when the cutting tool is received by the first slot. A locking member is positioned in and movable with respect to the housing. The locking member includes a second slot extending through the locking member for receiving the cutting tool, the second slot defined by at least one surface for engaging the cutting tool when the cutting tool is received by the second slot. A biasing member is configured for applying a force to the locking member to bias the at least one surface of the locking member into engagement with the cutting tool when the cutting tool is received by the second slot. The at least one surface of the locking member is movable between an engaged condition, in which the at least one surface of the locking member is positioned in the insertion pathway for engaging the cutting tool, and a released condition, in which the at least one surface of the locking member is removed from the insertion pathway for disengaging the cutting tool.

The invention further provides a cutting tool clamp mechanism for a power tool. The cutting tool clamp mechanism includes a housing supported on a spindle, the housing being configured to receive a cutting tool in an insertion pathway and the spindle being configured to drive the cutting tool. A first slot extends through the housing for receiving the cutting tool, the first slot being generally parallel to the insertion pathway for guiding the cutting tool along the insertion pathway. A locking member is positioned in and movable with respect to the housing, the locking member including a second slot extending through the plate for receiving the cutting tool and a surface for engaging the cutting tool when the cutting tool is received by the second slot. The second slot is movable between an engaged condition, in which the second slot is positioned in the insertion pathway and out of alignment with the first slot such that the surface of the locking member is engageable with the cutting tool, and a released condition, in which the second slot is positioned substantially in alignment with the first slot such that the surface of the locking member is disengageable from the cutting tool. A biasing member applies a force to the locking member to bias the locking member to the engaged condition. Other aspects of the invention will become apparent by consideration of the detailed description and accompanying drawings.

### BRIEF DESCRIPTION OF THE DRAWINGS

FIG. 1 is a perspective view of a blade clamp mechanism according to one embodiment of the invention.

FIG. 2 illustrates a perspective assembly view of the blade clamp mechanism shown in FIG. 1.

FIG. 3 illustrates another perspective assembly view of the blade clamp mechanism shown in FIG. 1.

FIG. 4 is a sectional view of the blade clamp mechanism taken along line 4-4 in FIG. 1, and showing an engaged condition of the blade clamp mechanism.

FIGS. 5A-5C are sectional views of the blade clamp mechanism of FIG. 1 showing a sequence of operation for the blade clamp mechanism.

FIG. 6 is a perspective view of a blade clamp mechanism according to another embodiment of the invention.

FIG. 7 illustrates a perspective assembly view of the blade clamp mechanism shown in FIG. 6.

FIG. 8 illustrates another perspective assembly view of the blade clamp mechanism shown in FIG. 6.

FIG. 9 is a sectional view of the blade clamp mechanism taken along line 9-9 in FIG. 6, and showing an engaged condition of the blade clamp mechanism.

FIGS. 10A-10C illustrate sectional views of the blade clamp mechanism of FIG. 1 showing a sequence of operation for the blade clamp mechanism.

FIG. 11 is a perspective view of a blade clamp mechanism according to another embodiment of the invention.

FIG. 12 illustrates a perspective assembly view of the blade clamp mechanism shown in FIG. 11.

FIG. 13 illustrates another perspective assembly view of the blade clamp mechanism shown in FIG. 11.

FIG. 14 illustrates yet another perspective assembly view of the blade clamp mechanism shown in FIG. 11.

FIG. 15 is a sectional view of the blade clamp mechanism taken along line 15-15 in FIG. 11, and showing an engaged condition of the blade clamp mechanism.

FIGS. 16A-16C illustrate sectional views of the blade clamp mechanism in FIG. 11 showing a sequence of operation for the blade clamp mechanism.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

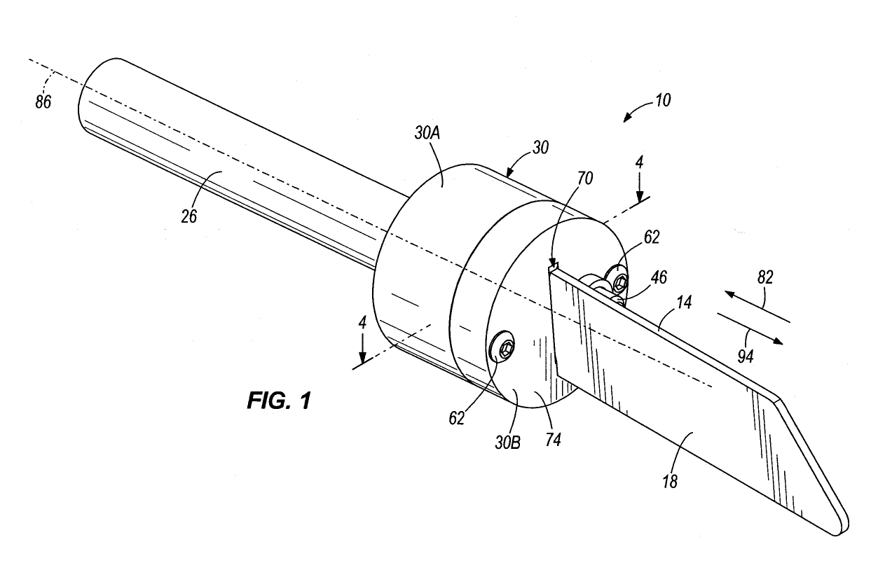

FIGS. 1-4 and 5A-5C illustrate a keyless blade clamp mechanism 10 for a power tool according to one embodiment of the invention. The illustrated blade clamp mechanism 10 is mounted on a reciprocating saw (not shown), and is shown engaging a saw blade 14, having a main portion 18 and a tang 22, to a spindle 26. In other embodiments, the blade clamp mechanism 10 is able to engage other types of cutting tools. The reciprocating saw includes the spindle 26 adapted to be mounted for reciprocation within a body (not shown) of the saw. A drive portion (not shown) is adapted to be driven by a wobble plate or other mechanism (not shown), as is generally known in the art.

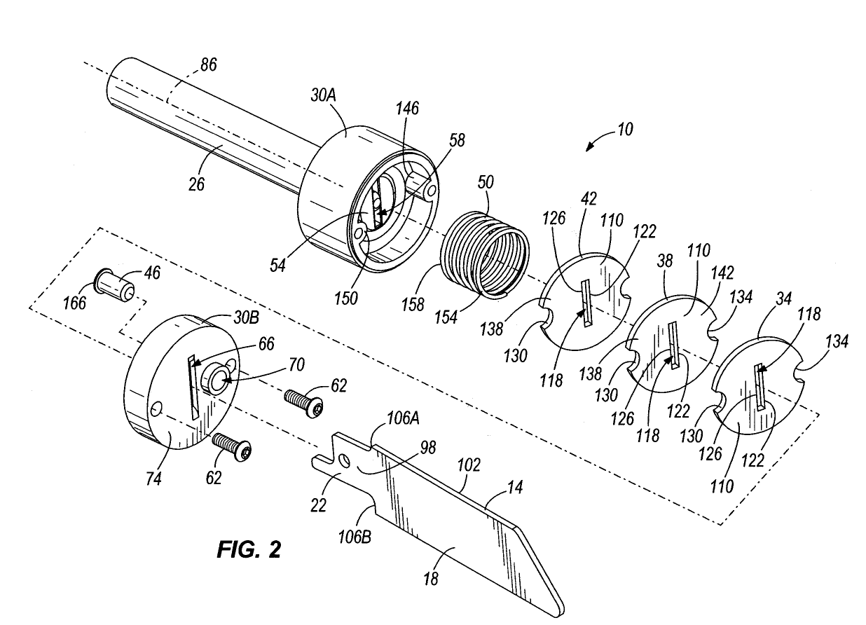

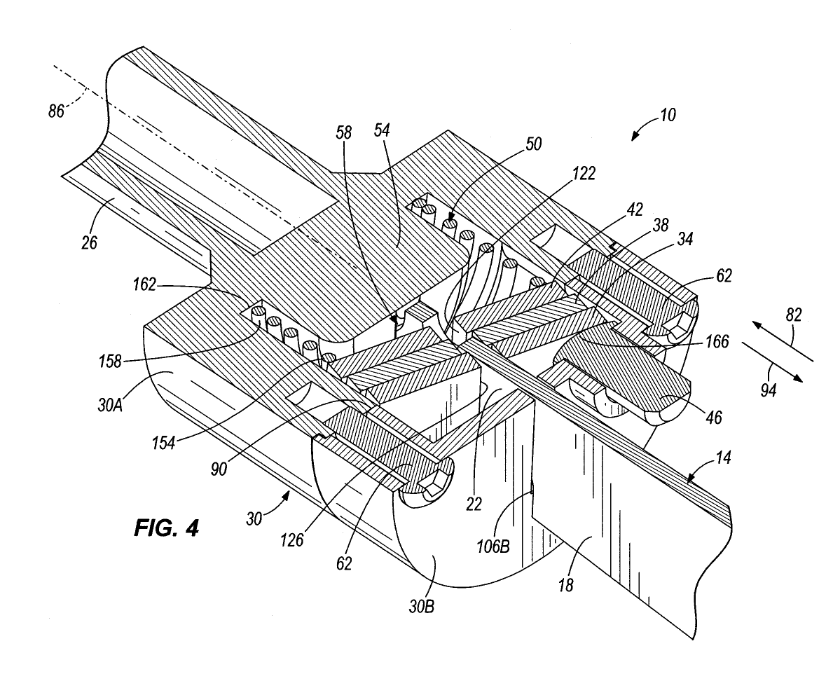

With reference to FIGS. 2-4, the blade clamp mechanism 10 includes a housing 30 (FIGS. 1 and 4), locking members 34, 38, 42, an actuator 46 and a biasing member 50, in which the housing 30 generally encompasses the locking members 34, 38, 42, the biasing member 50, and at least a portion of the actuator 46. The housing 30 of the blade clamp mechanism 10 has two members 30A, 30B; however in other embodiments the housing 30 may be a single member or have more than two members. The first member 30A includes a hub 54 having an aperture 58 for receiving the blade 14, and the members 30A, 30B are secured to one another by fasteners 62, such as bolts. In other embodiments, the members 30A, 30B may be secured by methods such as welding, clamping, snap rings and other fastening methods available to one skilled in the art. The illustrated embodiment shows the first member 30A as integrally formed with the spindle 26. In further embodiments, the first member 30A may be separate from the spindle 26 and coupled thereto by coupling means known in the art.

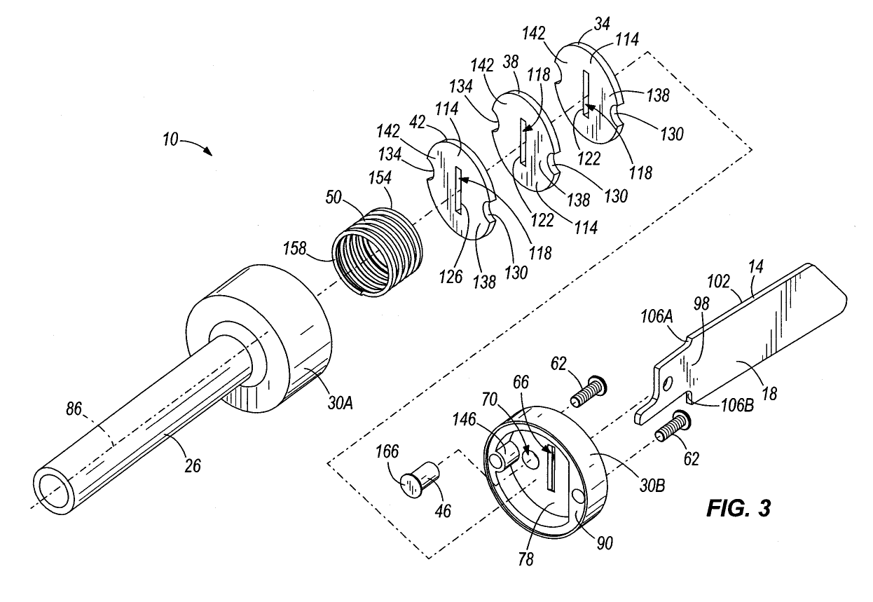

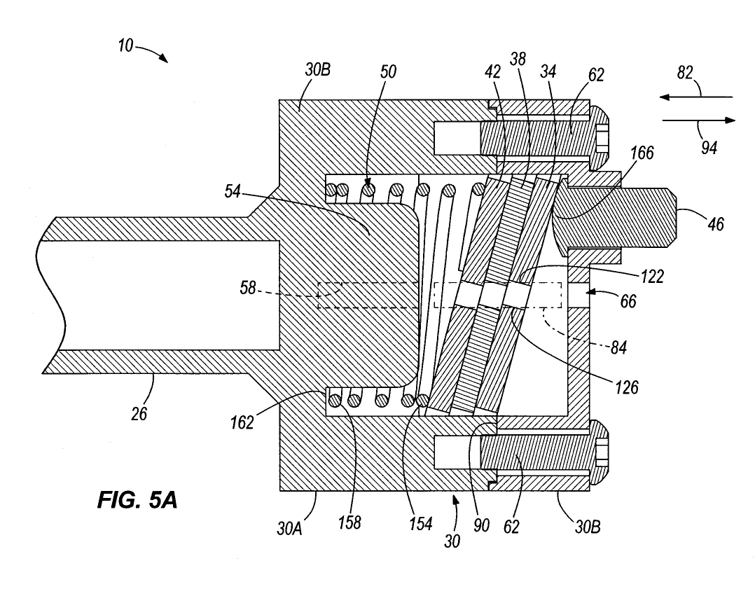

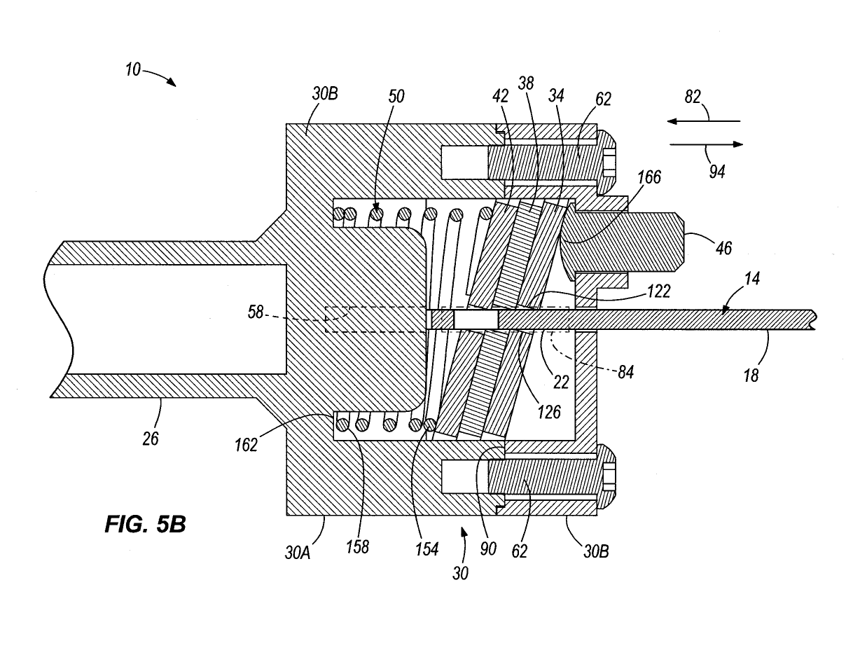

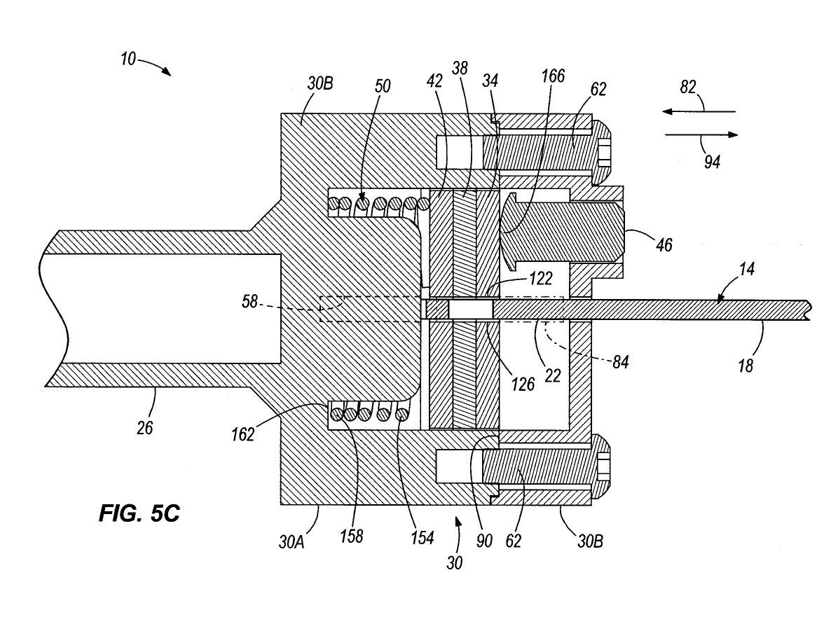

The second member 30B includes a slot 66 for receiving the blade 14 and an aperture 70 for receiving the actuator 46. The slot 66 extends through an exterior surface 74 (FIGS. 1 and 2) to an interior surface 78 (FIG. 3) of the second member 30B. The slot 66 receives the blade 14 in a first direction 82 (FIGS. 4 and 5A-5C) generally along a rotational axis 86 of the spindle 26 in the illustrated embodiment. The blade 14 is able to travel through the slot 66 toward and ultimately into the aperture 58 along a pathway 84, which hereinafter is referred to as an insertion pathway. In the illustrated embodiment, the insertion pathway 84 is slightly larger than the blade 14 and the geometry of the slot 66 guides the blade 14 along the insertion pathway 84. The interior surface 78 includes a locking member surface 90 (FIGS. 3, 4 and 5A-5C) that restricts axial displacement of a portion of the locking members 34, 38, 42 and a portion of the biasing member 50 in either of the first direction 82 or a second direction 94 opposite of the first direction 82, as shown in FIGS. 5A-5C and discussed further below.

In the illustrated embodiment, the saw blade 14 includes a first side surface or face 98, a second side surface or face 102 opposite the first side surface 98 and two shoulder portions 106A, 106B that form a transition from the tang 22 to the main portion 18. The thickness of the saw blade 14 is the distance between the first and second side surfaces 98, 102. When the tang 22 of the saw blade 14 is inserted into the slot 66 of the housing 30, at least the first shoulder portion 106A engages the housing 30.

In the illustrated embodiment, the three locking members 34, 38, 42 are pinch plates and each pinch plate 34, 38, 42 is stacked axially with respect to each other. It should be readily apparent to those of skill in the art that in further embodiments, fewer (e.g., one) or more pinch plates may be used. Referring to FIGS. 2 and 3, each pinch plate 34, 38, 42 includes a first surface 110, a second surface 114 opposite the first surface 110 and a slot 118 extending through the first surface 110 to the second surface 114. Each slot 118 is defined by a first slot surface 122 and a second slot surface 126 opposite the first slot surface 122, and each slot 118 has a width equal to the distance between the first and second slot surfaces 122, 126. The width of each slot 118 is greater than the thickness of the saw blade 14 to allow the saw blade 14, and specifically the tang 22 of the saw blade 14, to travel into and out of the slots 118, as shown in FIGS. 5A-5C.

Each pinch plate 34, 38, 42 also includes a pair of locking surfaces 130, 134 for restricting rotation of the pinch plates 34, 38, 42 about the rotational axis 86 of the spindle 26 within the housing 30. One of the locking surfaces 130 is positioned on a first portion 138, or end, of each pinch plate 34, 38, 42 and the other locking surface 134 is positioned on a second portion 142, or end, of each pinch plate 34, 38, 42, which is opposite of the first end 138. The first end 138 of the first pinch plate 34 is forced against the locking member surface 90 of the second member 30B by the biasing member 50 and the second end 142 is able to generally rotate or pivot with respect to the first end 138. That is, the first ends 138 of the pinch plates 34, 38, 42 generally define a pivot point in which the pinch plates 34, 38, 42 partially rotate. The second locking surface 134 (on the second end 142) of each pinch plate 34, 38, 42 is engaged with and is able to slide along a first guide member 146 (FIG. 3) of the housing members 30A, 30B. The guide member 146 restricts axial rotation of each pinch plate 34, 38, 42 while permitting movement of the second end 142 of the pinch plates 34, 38, 42 in the first and second directions 82, 94. The other locking surface 134 (on the first end 138) engages a second guide member 150 (FIG. 2) opposite of the first guide member 146 so as to further resist axial rotation of each pinch plate 34, 38, 42. Thus, the pinch plates 34, 38, 42 (i.e., the second ends 142) are able to rotate, pivot and/or translate within the housing 30.

In the illustrated embodiment, the biasing member 50 is a compression spring and is seated on the hub 54 to be guided generally along the rotational axis 86 of the spindle 26. In further embodiments, the biasing member 50 may be a plurality of springs imbedded in respective cavities of the housing 30. A first leg 154 of the biasing member 50 abuts the second surface 114 of the third pinch plate 42 and a second leg 158 of the biasing member 50 abuts a rear wall 162 (FIG. 4) of the housing member 30A. The biasing member 50 is thereby interconnected with the housing 30 and the pinch plate 42 for biasing the blade clamp mechanism 10 into engagement with the saw blade 14. The biasing member 50 applies a force (i.e., a biasing force) on the third pinch plate 42, and therein on the first and second pinch plates 34, 38, to bias the pinch plates 34, 38, 42 toward the interior surface 78 of the second housing member 30B so as to lock the blade 14 in the blade clamp mechanism 10.

The illustrated actuator 46 is a button actuator, although in other embodiments, the actuator may be various devices for transmitting motion to the pinch plates 34, 38, 42. The button actuator 46 passes through the aperture 70 of the housing 30, and includes a head 166 that abuts the interior surface 78 to prevent the button actuator 46 from ejecting from the housing 30. The button actuator 46 is user-actuated to induce movement of the pinch plates 34, 38, 42 so as to overcome the biasing force applied to the pinch plates 34, 38, 42 by the biasing member 50. In some embodiments, the actuator 46 is moved toward the pinch plates 34, 38, 42 by various mechanical devices. In other embodiments, the illustrated button actuator 46 may be positioned radially with respect to the housing 30. In addition, the button actuator 46 may have at least one member extending radially to engage the first surface 110 of the pinch plate 34 and oppose a biasing force applied by the biasing member 50.

Referring to FIGS. 4 and 5A-5C, the blade clamp mechanism 10 generally has three conditions: a no-blade condition, an engaged condition and a released condition. In the no-blade condition (FIG. 5A), the saw blade 14 is removed from the housing 30 and the biasing member 50 forces or biases the pinch plates 34, 38, 42 as far toward the interior surface 78 as permitted by the geometry of the housing 30 (i.e., the locking member surface 90), the actuator 46 and the pinch plates 34, 38, 42. The pinch plates 34, 38, 42 are angled within the housing 30 such that the second slot surface 126 of the slot 118 rests in the insertion pathway 84 of the blade 14.

In the engaged condition (FIGS. 4 and 5B), the saw blade 14 is installed or inserted into the housing 30. The pinch plates 34, 38, 42, and therein the slots 118, are angled within the housing 30 such that the first and second slot surfaces 122, 126 of the slots 118 form an obtuse or acute angle (i.e., a non-parallel angle) with respect to the side surfaces 98, 102 of the blade 14. As a result, the slot surfaces 122, 126 engage the blade 14 and lock the blade 14 therebetween.

In the released condition (FIG. 5C), the pinch plates 34, 38, 42 overcome the force of the biasing member 50 so that the saw blade 14 is able to be removed from the blade clamp mechanism 10. The actuator 46 is engaged with the first pinch plate 34 such that the second end 142 of each pinch plate 34, 38, 42 is angled or rotated toward the spindle 26 and away from the interior surface of the housing member 30B, as compared to the no-blade and engaged conditions. The slot surfaces 122, 126 of each pinch plate 34, 38, 42 are disengaged from and generally parallel to and aligned with the insertion pathway 84 of the blade, and therefore the blade side surfaces 98, 102 such that the blade 14 may be removed from the blade clamp mechanism 10.

In operation, a user inserts the blade 14 into the blade clamp mechanism 10 that is in the no-blade condition (FIG. 5A). The blade 14 is inserted in the first direction 82 by way of the housing slot 66, and thereby the pinch plate slots 118. The tang 22 of the blade 14 releasably engages the second slot surface 126 of the first pinch plate 34, which is angled into and rests in the insertion pathway 84 of the blade 14 within the housing 30. Engagement of the blade 14 and the second slot surface 126 forces the pinch plates 34, 38, 42 (i.e., the second ends 142) to rotate or displace generally in the first direction 82 against the biasing force of the biasing member 50. As the pinch plates 34, 38, 42 rotate, the respective slots 118 rotate and open into the insertion pathway 84 so as to allow continued insertion of the blade 14. The second end 142 of each pinch plate 34, 38, 42 rotates approximately about the respective first end 138, which is held between the locking member surface 90 of the second housing member 30B and the biasing member 50, as shown in FIGS. 4 and 5A-5C. The blade 14 slides against the first and second slot surfaces 122, 126 through the slots 118. The blade 14 continues to travel in the first direction 82 into the housing 30 until the blade 14 enters the aperture 58 of the hub 54 and the blade clamp mechanism 10 is in the engaged condition (FIGS. 4 and 5B).

As the blade 14 is inserted toward the engaged condition (FIG. 5B) or when a user attempts to pull the blade 14 in the second direction 94, the biasing member 50 biases or forces the pinch plates 34, 38, 42 to engage the side surfaces 98, 102 of the blade 14. The second end 142 of each pinch plate 34, 38, 42 rotates or moves away from the spindle 26 (i.e., in the second direction 94) until the first and second slot surfaces 122, 126 of the pinch plate slots 118 lock, or “pinch”, the blade 14. Locking occurs as a result of the slot surfaces 122, 126 of the pinch plates 34, 38, 42 entrapping the first blade side surface 98 and the second blade side surface 102, therein locking the blade 14 in the housing 30. The slot surfaces 122, 126 perform similar to that of a “finger-trap” as they permit displacement in the first direction 82 and prevent displacement in the second, opposite direction 94 (unintentional blade 14 disengagement).

To eject the blade 14 from the blade clamp mechanism 10, a user forces the button actuator 46 toward the spindle 26 to actuate the blade clamp mechanism 10 into the released condition (FIG. 5C). The button head 166 of the button actuator 46 slides toward and engages the first pinch plate 34, which forces displacement and rotation of the second end 142 of each pinch plate 34, 38, 42 toward the spindle 26, overcoming the biasing force of the biasing member 50. The first and second slot surfaces 122, 126 of the slots 118 release, at least partially, from the blade 14, therein releasing the pinching entrapment of the slot surfaces 122, 126 on the blade 14, as shown in FIG. 5C. Once the slot surfaces 122, 126 release from the side surfaces 98, 102 of the blade 14, the blade 14 may be withdrawn (i.e., disengaged) from the blade clamp mechanism 10 by a user. With the blade 14 removed, the pinch plates 34, 38, 42 are forced to return to the no-blade condition (FIG. 5A) by the biasing member 50.

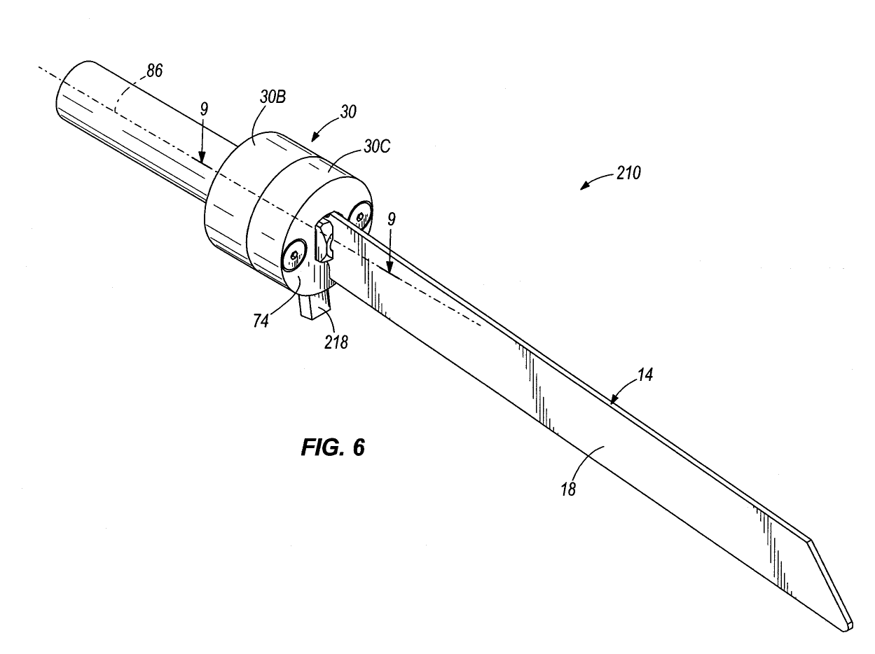

In further embodiments, the blade clamp mechanism 10 may include an ejection system for ejecting the blade 14 from the housing 30. One example of the ejection system is discussed below with respect to FIGS. 6-9 and 10A-10C.

In another embodiment, the pinch plates 34, 38, 42 may be hinged or pivotally fixed within the blade clamp mechanism 10 (e.g., hinged to the housing 30). As the button actuator 46 engages the pinch plates 34, 38, 42, the plates 34, 38, 42 rotate about a pivot and oppose the biasing spring force.

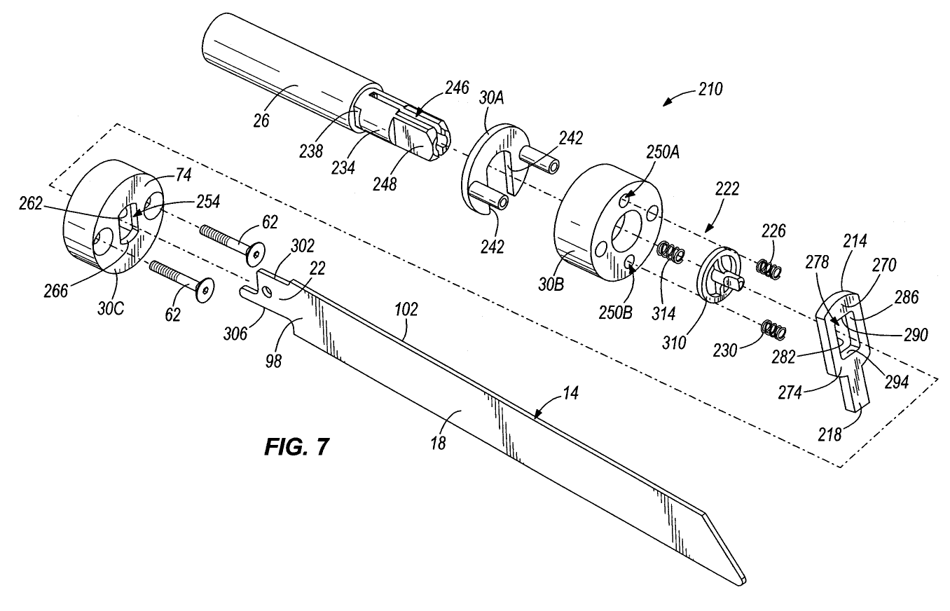

FIGS. 6-9 and 10A-10C illustrate a keyless blade clamp mechanism 210 according to another embodiment of the invention. The blade clamp mechanism 210 is similar to the blade clamp mechanism 10 shown in FIGS. 1-4 and 5A-5C; therefore, like structure will be identified by the same reference numerals. With reference to FIGS. 7-9 and 10A-10C, the blade clamp mechanism 210 of this embodiment includes a pinch plate 214, an actuator 218 integrally formed with the pinch plate 214, and an ejection system 222 for automatically ejecting the blade 14 from the blade clamp mechanism 210. In addition, the blade clamp mechanism 210 includes two biasing members 226, 230 (e.g., compression springs), although in other embodiments, a single biasing member, for example the biasing member 50 shown in FIGS. 1-4 and 5A-5C, is used to force engagement of the pinch plate 214 with the blade 14.

With reference to FIGS. 7-9 and 10A-10C, the housing 30 has three members 30A, 30B, 30C secured to one another by the fasteners 62; however in other embodiments the housing 30 may be more or fewer than three members. The housing member 30A is coupled to an assembly seat 234 of the spindle 26 by way of mating planar surfaces 238, 242 on the assembly seat 234 and the housing 30A, respectively. The planar surfaces 238, 242 align with one another and prevent rotational and axial displacement of the housing 30 with respect to the spindle 26 (only one of the planar surfaces 238 of the spindle 26 are shown). In the illustrated embodiment, the assembly seat 234 extends into the housing 30 for receiving the blade 14, such that an axially extending slot 246 of the assembly seat 234 receives the blade 14.

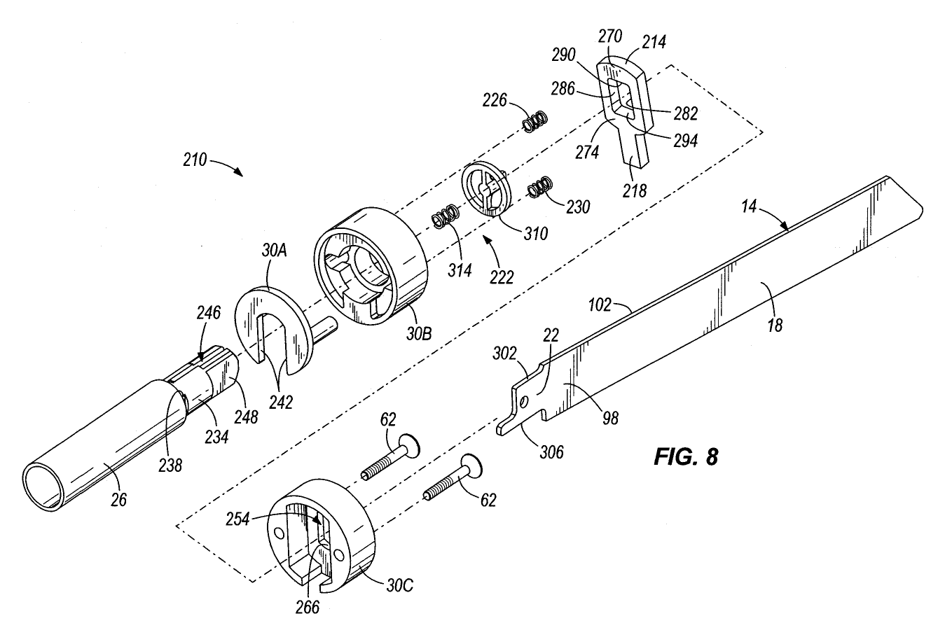

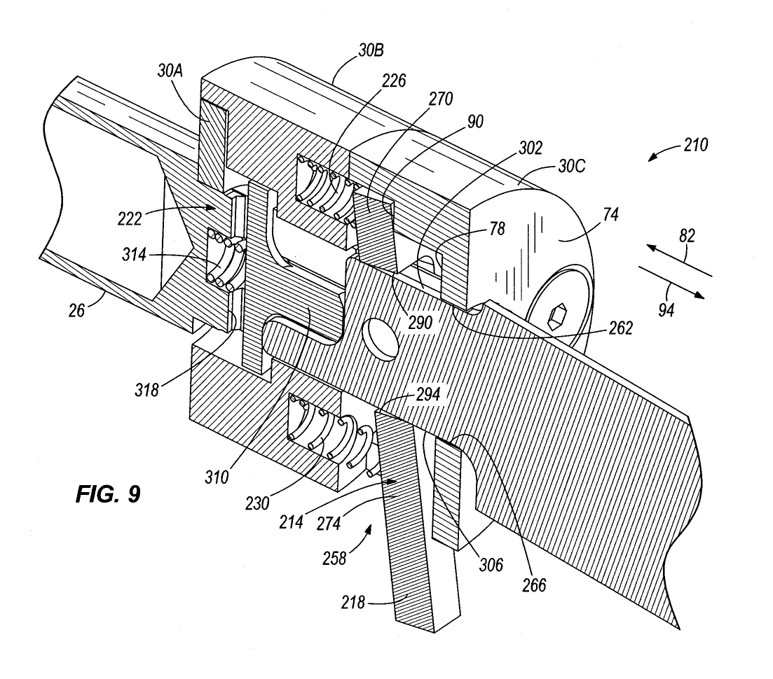

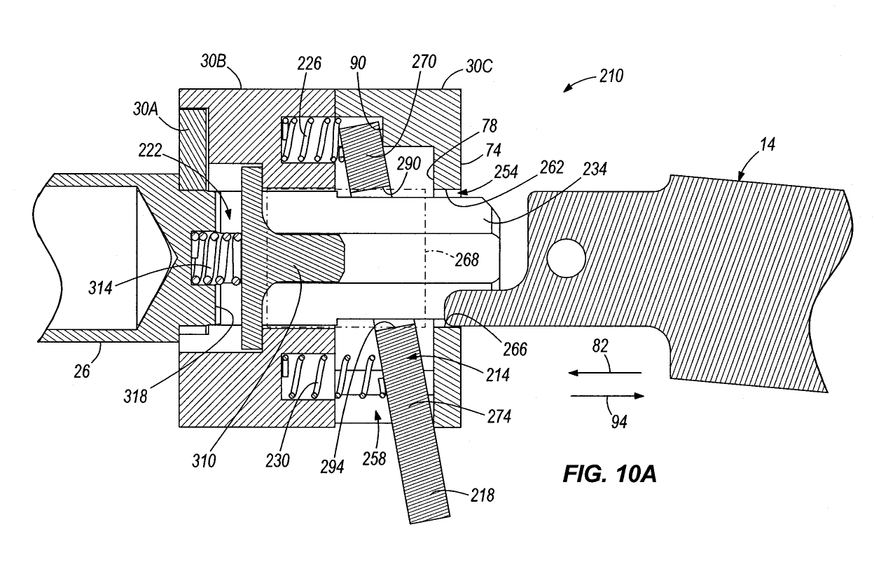

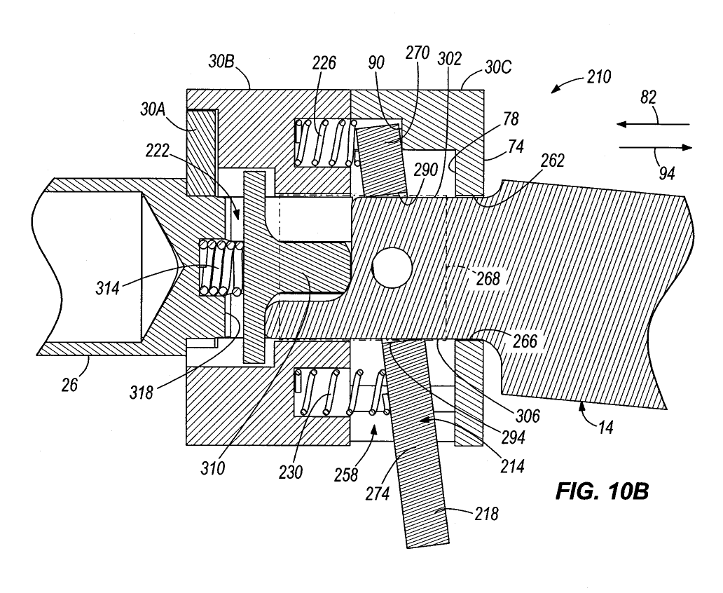

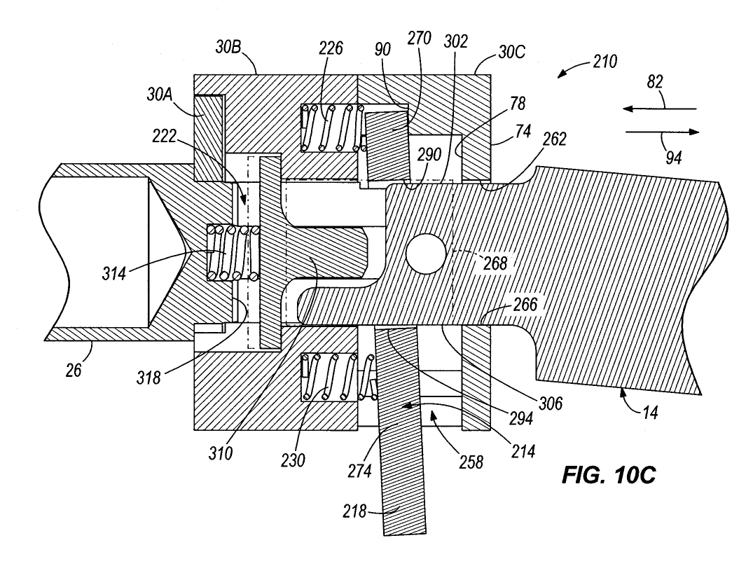

As shown in FIGS. 7, 9 and 10A-10C, the second housing member 30B includes cavities 250A, 250B, in which the respective biasing members 226, 230 reside. The third housing member 30C includes a slot or aperture 254 (FIGS. 7 and 10A) for receiving the assembly seat 234 and an opening 258 (FIGS. 8, 9 and 10A-10C) for the actuator 218 to extend from the housing 30. The aperture 254 extends through the exterior surface 74 (FIGS. 6, 7 and 9) to the interior surface 78 (FIG. 8) of the third housing member 30C. The aperture 254 is rectangular shaped and is partially defined by a first aperture surface 262 and a second aperture surface 266 opposite of the first aperture surface 262, in which a length of the aperture 254 is defined by the distance between the first and second aperture surfaces 262, 266. The aperture 254 is sized to receive the assembly seat 234 of the spindle 26, which receives the blade 14 in the first direction 82 (FIGS. 9 and 10A-10C) generally along the rotational axis 86 of the spindle 26 in the illustrated embodiment. The blade 14 is able to travel through the aperture 254 and into the slot 246 of the assembly seat 234, which defines a pathway 268 hereinafter referred to as an insertion pathway. In the illustrated embodiment, the insertion pathway 268 is slightly larger than the blade 14 and the aperture surfaces 262, 266 guide the blade 14 along the insertion pathway 268. The interior surface 78 includes the locking member surface 90 (FIGS. 8 and 9), which restricts axial displacement of a portion of the pinch plate 214 and the first biasing member 226 in either of the first and second directions 82, 94, as shown in FIGS. 10A-10C.

The pinch plate 214 includes a first end 270, or portion, forced against the locking member surface 90 of the housing member 30C, a second end 274, or portion, opposite of the first portion 270, and an aperture or slot 278, which is positioned between the first and second portions 270, 274. The first portion 270 is forced against the locking member surface 90 of the housing member 30C by the biasing member 226 and the second portion 274 is able to generally rotate or pivot about the first portion 270.

The slot 278 is generally rectangular shaped to receive and surround the assembly seat 234, and the slot 278 is defined by two sets of opposing surfaces: a first spindle surface 282, a second spindle surface 286 opposite the first spindle surface 282, and first and second engaging surfaces 290, 294 extending between the first and second spindle surfaces 282, 286. The first and second spindle surfaces 282, 286 slide along an exterior surface 298 of the spindle 26 (i.e., the assembly seat 234) so as to guide the pivoting movement of the pinch plate 214 and prevent rotation of the pinch plate 214 about the rotational axis 86 of the spindle 26. The first and second engaging surfaces 290, 294 releasably engage first and second edges 302, 306 of the blade 14 (i.e., upper and lower surfaces of the blade 14 spanning the thickness of the blade 14 as shown in FIGS. 7 and 8), which are oriented 90° counterclockwise with respect to the side surfaces 98, 102. The slot 278 has a length equal to the distance between the first and second engaging surfaces 290, 294. The length of the slot 278 is greater than the width of the tang 22 of the saw blade 14 (i.e., the distance between the surfaces 98, 102 of the blade 14) to allow the blade 14 to travel into and out of the slot 278, as shown in FIGS. 10A-10C.

The biasing members 226, 230 constitute an embodiment of a first biasing member and apply a force (i.e., a biasing force) on the pinch plate 214 to bias the pinch plate 214 toward the interior surface 78 of the third housing member 30C so as to lock the blade 14 in the blade clamp mechanism 210. The first biasing member 226 (e.g., a spring) extends between the second housing member 30B and the first portion 270, and the second biasing member 230 extends between the second housing member 30B and the second portion 274 of the pinch plate 214. The first and second biasing members 226, 230 cooperate to bias the pinch plate 214 toward the third housing member 30C. The locking member surface 90 of the housing 30 inhibits movement of the first portion 270 of the pinch plate 214 such that the first portion 270 defines a pivot point of the pinch plate 214. In other embodiments, various devices may be used to bias the pinch plate 214 into engagement with the saw blade 14.

In the illustrated embodiment, the actuator 218 is a lever actuator that is integrally formed with the second portion 274 of the pinch plate 214 so as to transmit motion to and generally pivot the pinch plate 214. In other embodiments, the actuator 218 may be various devices for transmitting motion to the pinch plate 214. With reference to FIGS. 10A-10C, the lever actuator 218 passes through the opening 258 formed in the third housing member 30C and extends from the housing 30. The lever actuator 218 is user-actuated to induce movement of the pinch plate 214 and overcome the biasing force applied to the pinch plate 214 by the second biasing member 230. In some embodiments, the actuator 218 is moved toward the pinch plate 214 by various mechanical devices.

Referring to FIGS. 7-9 and 10A-10C, the ejection system 222 includes an ejecting body 310, or plunger, and an ejecting member 314 (e.g., a spring), or plunger biasing member. The ejecting member 314 constitutes a second biasing member and is positioned to force the blade 14 out of the blade clamp mechanism 210 when the blade clamp mechanism 210 is in the released condition. The housing 30 is adapted to the assembly seat 234 of the spindle 26 to facilitate operation of the ejection system 222. In further embodiments, the ejection system 222 may be eliminated.

Referring to FIGS. 9 and 10A-10C, the blade clamp mechanism 210 generally has three conditions: a no-blade condition, an engaged condition and a released condition. In the no-blade condition (FIG. 10A), the saw blade 14 is removed from the housing 30 and the biasing members 226, 230 force or bias the pinch plate 214 as far toward the interior surface 78 as permitted by the geometry of the housing 30 (i.e., the locking member surface 90), the actuator 218 and the pinch plate 214. The pinch plate 214 is angled within the housing 30 such that a portion of the first engaging surface 290 of the slot 278 lies in the insertion pathway 268 of the blade 14.

In the engaged condition (FIGS. 9 and 10B), the saw blade 14 is installed or inserted into the housing 30. The pinch plate 214, and therein the slot 278, are angled within the housing 30 such that the first and second engaging surfaces 290, 294 of the slot 278 form an obtuse or acute angle (i.e., a non-parallel angle) with respect to the first and second edges 302, 306 of the blade 14. As a result, the engaging surfaces 290, 294 lock or engage the blade 14 therebetween.

In the released condition (FIG. 10C), the pinch plate 214 overcomes the biasing member 230 to allow removal of the saw blade 14 from the blade clamp mechanism 210. The actuator 218 is pivoted such that second portion 274 of the pinch plate 214 is rotated toward the second housing member 30B, as compared to a position of the second portion 274 in the no-blade and engaged conditions. The engaging surfaces 290, 294 of the pinch plate 214 are disengaged from and generally parallel to and aligned with the slot 254, and therein the blade edges 302, 306 such that the blade 14 may be removed from the blade clamp mechanism 210. In the illustrated embodiment, when the pinch plate 214 is in the released condition, the saw blade 14 is automatically expelled from the mechanism 210 by the blade ejection system 222 (FIGS. 7-9 and 10A-10C), which is discussed further below.

In operation, a user inserts the blade 14 into the blade clamp mechanism 210 that is in the no-blade condition (FIG. 10A). The blade 14 is inserted in the first direction 82 by way of the slot 246 in the spindle 26, through the aperture 254 in the housing 30, and thereby into the pinch plate aperture or slot 278. The tang 22 of the blade 14 releasably engages the first engaging surface 290 of the pinch plate 214, which is angled into and rests in the insertion pathway 268 of the blade 14 within the housing 30. Engagement of the blade 14 and the first engaging surface 290 forces the pinch plate 214 (i.e., the second portion 274) to pivot or displace generally in the first direction 82 against the biasing force of the biasing member 230. As the pinch plate 214 rotates, the slot 278 rotates and opens into the insertion pathway 268 to allow continued insertion of the blade 14. The second portion 274 of the pinch plate 214 rotates approximately about the first portion 270 of the pinch plate 214, which is held between the locking member surface 90 of the third member 30B of the housing 30 and the biasing member 226, as shown in FIGS. 9 and 10A-10C. The blade 14 slides against the first and second engaging surfaces 290, 294 through the slot 278, and continues to travel in the first direction 82 into the housing 30 and contacts the plunger 310, thereby opposing the biasing force of the ejecting member 314 and moving the plunger 310 in the first direction 82. The plunger 310 is forced by the blade 14 toward the first housing member 30A. In the illustrated embodiment, the blade clamp mechanism 210 is in the engaged condition (FIGS. 9 and 10B) when the plunger 310 contacts the first housing member 30A and the blade 14 is fully inserted into the slot 246. In other embodiments, the plunger 310 is spaced apart from the first housing member 30A in the engaged condition such that the blade 14 is partially inserted, or the blade clamp mechanism 210 is in the engaged condition when the blade 14 contacts a rear wall 318 of the spindle 26.

As the blade 14 is inserted toward the engaged condition (FIG. 10B) or when a user attempts to pull the blade 14 in the second direction 94 the biasing member 230 biases or forces the pinch plate 214 to engage the edges 302, 306 of the blade 14. The second portion 274 of the pinch plate 214 pivots or moves away from the second housing 30B (i.e., in the second direction 94) until the first and second engaging surfaces 290, 294 of the pinch plate slot 278 locks, or “pinches”, the blade 14. Locking occurs as a result of the engaging surfaces 290, 294 of the pinch plate 214 entrapping the first blade edge 302 and the second blade edge 306, therein locking the blade 14 in the housing 30. The engaging surfaces 290, 294 perform similar to that of a “finger-trap” as they permit displacement in the first direction 82 and prevent displacement in the second, opposite direction 94 (unintentional blade disengagement).

To eject the blade 14 from the blade clamp mechanism 210, a user forces the lever actuator 218 toward the spindle 26 (generally in the first direction 82) to actuate the blade clamp mechanism 210 into the released condition (FIG. 10C). The actuator 218 forces displacement and rotation of the second portion 274 of the pinch plate 214 toward the second housing member 30B, overcoming the biasing force of the second biasing member 230. The first and second engaging surfaces 290, 294 of the slot 278 release, at least partially, from the blade 14, therein releasing the pinching entrapment of the engaging surfaces 290, 294 on the blade 14, as shown in FIG. 10C. The displacement or rotation of the pinch plate 214 toward the spindle 26 and release of the engaging surfaces 290, 294 from the edges 302, 306 of the blade 14 allows the blade 14 to be automatically ejected (i.e., disengaged) from the blade clamp mechanism 210 by the blade ejection system 222. The blade 14 is ejected by the ejector 310, which is biased against the blade 14 by the biasing member 314 compressed between the ejector 310 and the spindle 26. With the blade 14 removed, the pinch plate 214 is forced to return to the no-blade condition (FIG. 10A) by the second biasing member 230.

In a further embodiment, there may be one spring or more than two springs for biasing the pinch plates 214. In another embodiment, the pinch plate 214 may engage at least one surface of the blade 14 or the pinch plate 214 may engage surfaces of the blade 14 oriented 90° with respect to one another.

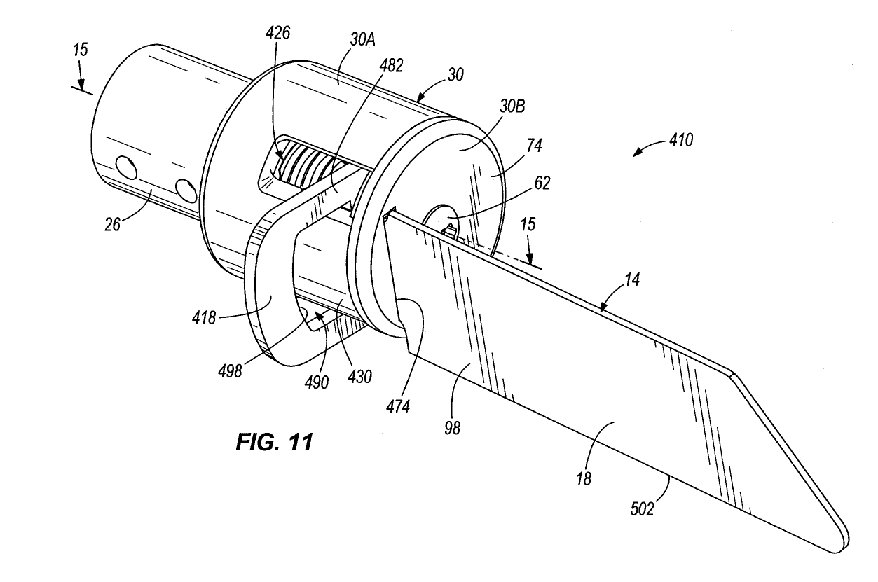

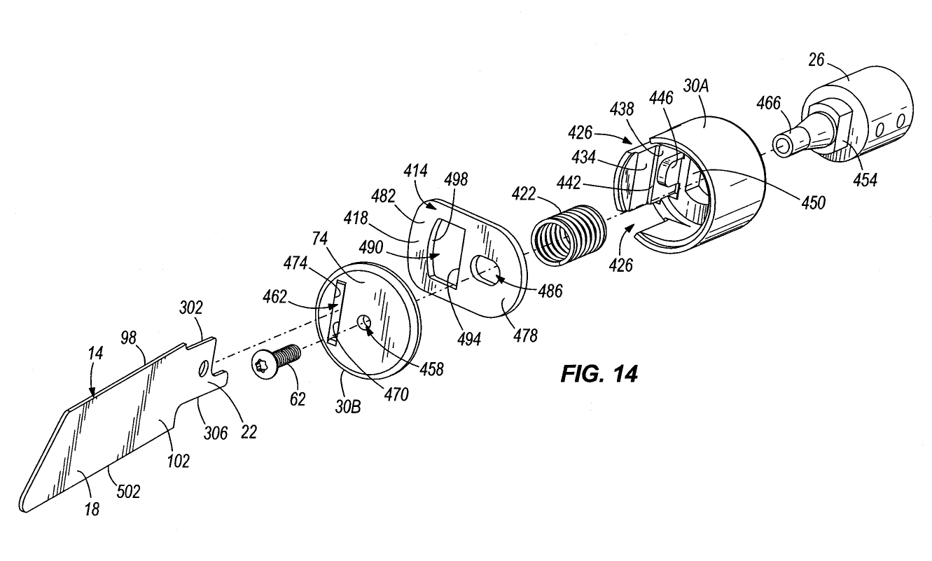

FIGS. 11-15 and 16A-16C illustrate a keyless blade clamp mechanism 410 according to another embodiment of the invention. The blade clamp mechanism 410 is similar to the blade clamp mechanism 10 shown in FIGS. 1-4 and 5A-5C; therefore, like structure will be identified by the same reference numerals. The blade clamp mechanism 410 includes a pinch plate 414, an actuator 418 integrally formed with the pinch plate 414, and a biasing member 422 positioned between the housing 30 and the pinch plate 414.

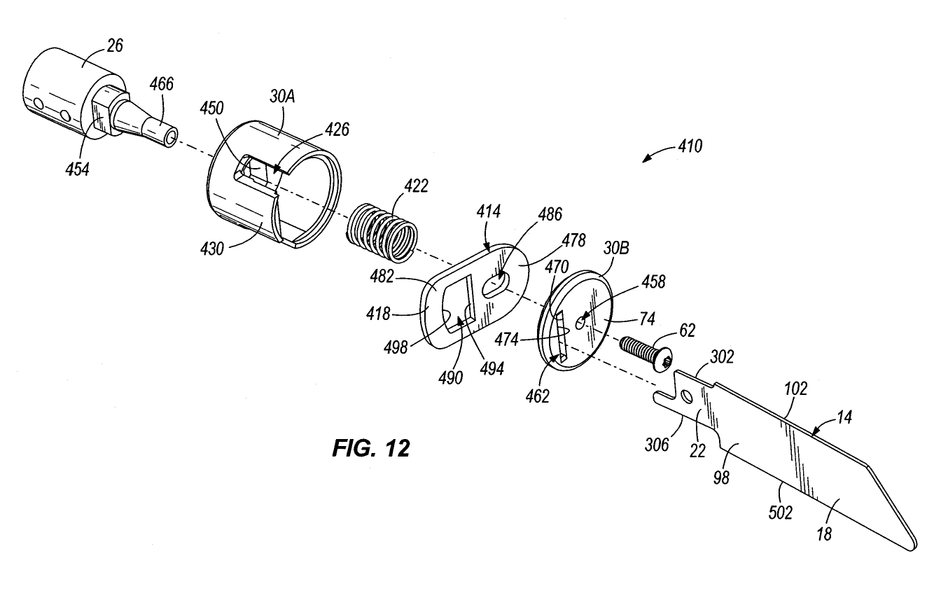

With respect to FIGS. 12-14, the housing 30 has two housing members: a first housing member 30A and a second housing member 30B. The first housing member 30A includes a pair of openings 426 extending through the housing member 30A and defining a housing portion 430 therebetween. The housing portion 430 includes a first interior surface 434, a second interior surface 438 elevated toward the rotational axis 86 with respect to the first interior surface 434, a sloped surface 442 providing a transition between the first and second interior surfaces 434, 438, and a D-shaped stop 446 extending from the second interior surface 438 toward the rotational axis 86. The first interior surface 434 guides insertion of the blade 14 into the housing 30 and the second interior surface 438 is able to engage or lock against the first side surface 98 of the saw blade 14. The stop 446 abuts the tang 22 of the blade 14 when the blade 14 is fully inserted. The first housing member 30A also includes a pair of planar surfaces 450 for engaging corresponding planar surfaces 454 of the spindle 26. The mating of the planar surfaces 450, 454 resists rotational movement of the housing 30 with respect to the spindle 26.

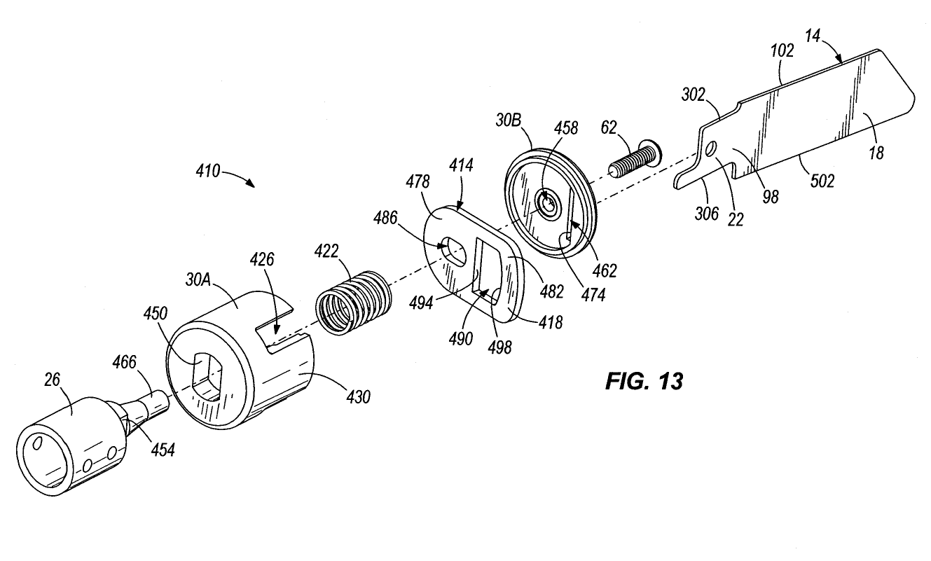

The second housing member 30B includes an aperture 458 for receiving the fastener 62 and a slot 462 for receiving the saw blade 14. The aperture 458 extends through the exterior surface 74 (FIGS. 11, 12 and 14) to the interior surface 78 (FIG. 13) of the second housing member 30B. The second housing member 30B is secured to the first housing member 30A via the fastener 62, which is threaded into an assembly seat or receiving end 466 of the spindle 26. In other embodiments, the second housing member 30B is secured to the first housing member 30A and/or the spindle 26 using various known securing devices (e.g., bolts, welds, adhesive, etc.). In other embodiments, the spindle 26 and the first housing member 30A are integrally formed with one another.

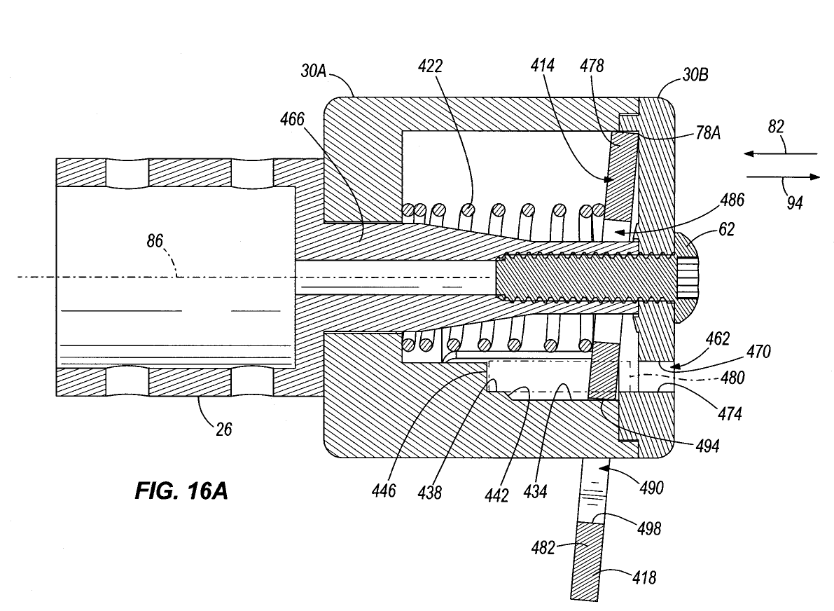

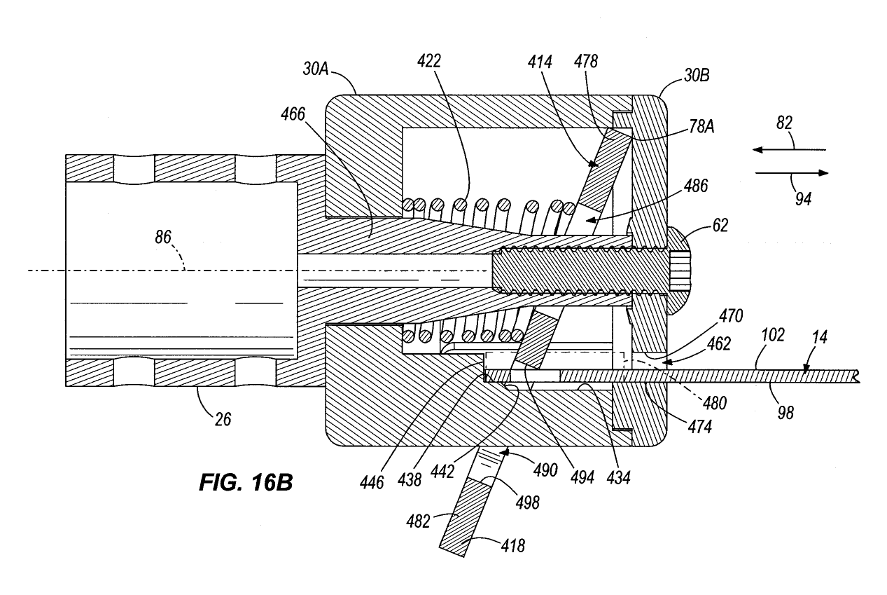

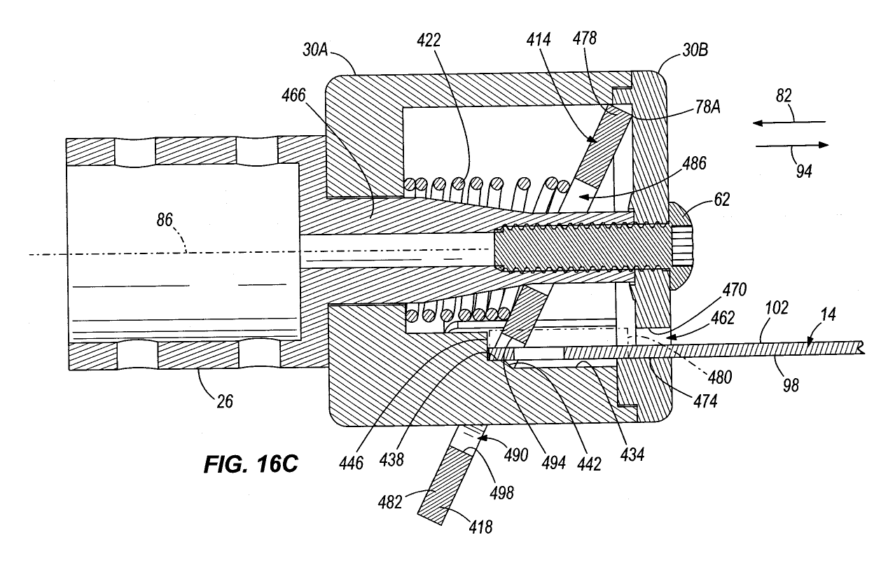

The slot 462 is defined, in part, by a first surface 470 and a second surface 474 positioned opposite the first surface 470. The slot 462 is rectangular shaped and has a width that is slightly greater than a thickness of the saw blade 14. The greater width of the slot 462 allows the saw blade 14 to float or slide between the first and second surfaces 470, 474 of the slot 462 when the saw blade 14 is disengaged from the blade clamp mechanism 410. The blade 14 is able to travel through the slot 462, which defines a pathway 480 hereinafter referred to as an insertion pathway. In the illustrated embodiment, the insertion pathway 480 is slightly larger than the blade 14 and the slot 462 is sized and shaped such that the surfaces 470, 474 guide the blade 14 along the insertion pathway 480. A portion of the interior surface 78A restricts axial displacement of a portion of the pinch plate 414 and the biasing member 422 in either of the first and second directions 82, 94, as shown in FIGS. 16A-16C.

The pinch plate 414 includes a first end 478, or portion, forced against the interior surface 78 (FIG. 13) of the housing member 30B, a second end 482, or portion opposite the first portion 478, a first aperture 486, and a second aperture 490 with the first and second apertures 486, 490 positioned between the first and second portions 478, 482. The first portion 478 is forced against the interior surface 78 of the housing member 30B by the biasing member 422 and the second portion 482 is able to generally rotate or pivot about the first portion 478. The first aperture 486 is an elongated opening, which allows the receiving end 466 of the spindle 26 to extend through the first aperture 486 and the pinch plate 414 to move with respect to the spindle 26.

The second aperture 490 is generally D-shaped as defined by an engaging surface 494, which is generally planar and proximate the first aperture 486, and a curved surface 498 positioned opposite the engaging surface 494. The housing portion 430 extends through the second aperture 490 such that the pinch plate 414 surrounds the housing portion 430 and is slidable within the openings 426 of the first housing member 30A. When the blade clamp mechanism 410 is assembled, the engaging surface 494 is positioned inside the housing 30 and is engageable with the saw blade 14, and the curved surface 498 is positioned outside of the housing 30 and is spaced a variable distance away from the housing 30. The variable distance allows the pinch plate 414 (i.e., the engaging surface 494) to slide within the openings 426 and therein engage and disengage with the saw blade 14 (i.e., the second side surface 102 of the blade 14). The pinch plate 414 is able to move or translate axially with respect to the spindle 26 and the housing 30. In the illustrated embodiment, axial movement of the pinch plate 414 is limited by the axial length of the openings 426, the biasing member 422, and the interior surface 78A. In other embodiments, the pinch plate 414 is hinged or fixed to the housing 30 and pivots with respect to the housing 30.

In the illustrated embodiment, the biasing member 422 is a compression spring, although in other embodiments, the biasing member 422 is any device for engaging the pinch plate 414 to the saw blade 14. The biasing member 422 (e.g., a spring) extends between the first housing member 30A and the pinch plate 414. The biasing member 422 applies a force (i.e., a biasing force) on the pinch plate 414 to bias the pinch plate 414 toward the interior surface 78 of the second housing member 30B and to lock the blade 14 in the blade clamp mechanism 410. The engaging surface 494 of the pinch plate 414 engages the blade side surface 102 of the saw blade 14 to prevent removal of the blade 14 from the blade clamp mechanism 410. The interior surface 78A of the housing 30 inhibits movement of the first portion 478 of the pinch plate 414 such that the first portion 478 defines a pivot point of the pinch plate 414. In other embodiments, various devices may be used to bias the pinch plate 414 into engagement with the saw blade 14.

As described above, the actuator 418 is integrally formed with the pinch plate 414 so as to transmit motion to and generally rotate the pinch plate 414. In the illustrated embodiment, the actuator 418 is positioned outside of the housing 30 and proximate the curved surface 498 of the pinch plate 414. The actuator 418 is engageable by, for example, a user and transmits rotational-like movement to the second portion 482 of the pinch plate 414.

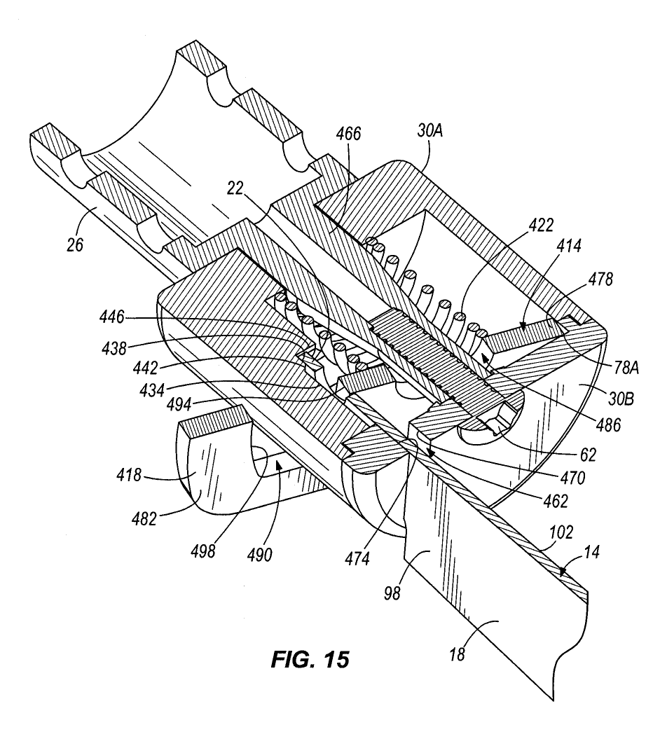

Referring to FIGS. 15 and 16A-16C, the blade clamp mechanism 410 generally has three conditions: a no-blade condition, an engaged condition and a released condition. In the no-blade condition (FIG. 16A), the saw blade 14 is removed from the housing 30 and the biasing member 422 forces the pinch plate 414 as far toward the interior surface 78 as permitted by the geometry of the housing 30 (i.e., the interior surface 78A) and the pinch plate 414 (i.e., the engaging surface 494). The biasing member 422 forces the engaging surface 494 to rest against the housing portion 430 (i.e., the first surface 434) and thereby positions the engaging surface 494 in the insertion pathway 480 of the blade 14. That is, the insertion pathway 480 is blocked by the pinch plate 414. In other embodiments, the biasing member 422 may force the pinch plate 414 to rest against the second housing member 30B.

In the engaged condition (FIGS. 15 and 16B), the saw blade 14 is installed or inserted into the housing 30. The pinch plate 414, and therein the slot 462, are angled within the housing 30 such that the engaging surface 494 of the slot 462 forms an obtuse or acute angle (i.e., a non-parallel angle) with respect to the first and second side surfaces 98, 102 of the blade 14. As a result, the engaging surface 494 locks or engages the blade 14 against the housing 30.

In the released condition (FIG. 16C), the pinch plate 414 overcomes the biasing member 422 to allow removal of the saw blade 14 from the blade clamp mechanism 410. The actuator 418 is pivoted such that second portion 482 of the pinch plate 414 is pivoted toward the spindle 26 to further compress the biasing member 422, as compared to the compressed state of the biasing member 422 in the no-blade and engaged conditions. The engaging surface 494 of the pinch plate 414 is disengaged from the blade side surface 102 such that the blade 14 may be removed from the blade clamp mechanism 410.

In operation, the saw blade 14 is able to be inserted in a first orientation and a second orientation in which the saw blade 14, and specifically a cutting edge 502 of the saw blade 14, is rotated 180° from the first orientation. With the orientation selected, a user inserts the blade 14 into the blade clamp mechanism 410 that is in the no-blade condition (FIG. 16A). The saw blade 14 is inserted or slid into the housing 30 in the first direction 82 by way of the slot 462 in second housing member 30B and thereby into the pinch plate slot 490. The tang 22 of the blade 14 releasably engages the engaging surface 494 of the pinch plate 414, which is angled into and rests in the insertion pathway 480 of the blade 14 within the housing 30. Engagement of the blade 14 and the engaging surface 494 forces the pinch plate 414 (i.e., the second portion 482) to pivot and displace generally in the first direction 82 against the biasing force of the biasing member 422. In the illustrated embodiment, the pinch plate 414 is installed hands-free, or in other words, without using the actuator 418 to move the pinch plate 414.

As the saw blade 14 is inserted, the tang 22 of the saw blade 14 slides across the second surface 474 of the slot 462 in the second housing member 30B. The pinch plate 414 pivots slightly in the first direction 82 to separate the engaging surface 494 from the housing portion 430 in response to insertion of the blade 14 into the housing 30. The second portion 482 of the pinch plate 414 rotates approximately about the first portion 478 of the pinch plate 414, which is held between the interior surface 78 of the second member 30B of the housing 30 and the biasing member 422, as shown in FIGS. 15 and 16A-16C. The separation of the engaging surface 494 from the housing portion 430 opens or clears the insertion pathway 480 to allow continued insertion of the blade 14, and the blade 14 slides against and between the engaging surface 494 and the second surface 474 of the slot 462.

The tang 22 of the blade 14 slides across the second surface 474 of the second member 30B, and thereby guides the tang 22 to and across the second interior surface 438 of the first member 30A. The first side surface 98 continues to slide against the second interior surface 438 until the tang 22 engages the stop 446 of the housing member 30A. As the blade 14 is inserted toward the engaged condition (FIG. 16B) or when a user attempts to pull the blade 14 in the second direction 94, the biasing member 422 biases or forces the pinch plate 414 (i.e., the engaging surface 494) to engage the side surface 102 of the blade 14, which forces the blade 14 (i.e., the first side surface 98) against the second interior surface 438 of the housing member 30A. In addition, if a user attempts to pull the blade 14 in the second direction 94 when in the engaged condition, the biasing member 422 increases the amount of force applied to the pinch plate 414, and the pinch force applied by the plate 414 to the blade 14 increases. The second portion 482 of the pinch plate 414 rotates or moves in the second direction 94 until the engaging surface 494 of the pinch plate slot 462 locks, or “pinches”, the blade 14. Locking occurs as a result of the engaging surface 494 of the pinch plate 414 entrapping the blade 14 against the second slot surface 474 and the second interior surface 438, therein locking the blade 14 in the housing 30.

The pinch plate 414 compels a three-point engagement for the saw blade 14 via the engagement of the engaging surface 494, the second slot surface 474 of the housing slot 462, and the second interior surface 438 of the housing member 30A. The engaging surface 494, the second slot surface 474, and the second interior surface 438 perform similar to that of a “finger-trap” as they permit displacement in the first direction 82 and prevent displacement in the second, opposite direction 94 (unintentional blade disengagement).

To remove or disengage the saw blade 14 from the blade clamp mechanism 410, a user forces the actuator 418 generally in the first direction 82 to actuate the blade clamp mechanism 410 into the released condition (FIG. 16C). The actuator 418 forces displacement and rotation of the second portion 482 of the pinch plate 414 away from the second housing member 30B, overcoming the biasing force of the biasing member 422. The engaging surface 494 of the slot 462 releases, at least partially, from the blade 14, therein releasing the pinching entrapment of the engaging surface 478 on the blade 14, as shown in FIG. 16C. The displacement or rotation of the pinch plate 414 toward the spindle 26 and release of the engaging surface 494 from the side surface 102 of the blade 14 allows the blade 14 to be withdrawn (i.e., disengaged) from the blade clamp mechanism 410 by a user or automatically using a blade ejection system (e.g., the ejection system 222 shown in FIGS. 6-9 and 10A-10C). With the blade 14 removed, the pinch plate 414 is forced to return to the no-blade condition (FIG. 16A) by the biasing member 422 such that the pinch plate 414 is angled within and pinched against the first housing member 30A.

Although the invention has been described in detail with reference to certain preferred embodiments, variations and modifications exist within the scope and spirit of one or more independent aspects of the invention as described.

What is claimed is:

1. A cutting tool clamp mechanism for a power tool, the cutting tool clamp mechanism comprising:
a housing supported on a spindle, the spindle being configured to drive a cutting tool;
a locking member positioned in and movable with respect to the housing, the locking member including a slot extending through the locking member for receiving the cutting tool, the slot defined by at least one surface for engaging the cutting tool when the cutting tool is received by the slot; and
a biasing member configured for applying a force to the locking member to bias the at least one surface of the locking member into engagement with the cutting tool when the cutting tool is received by the slot, wherein the locking member is movable between an engaged condition, in which the slot receives the cutting tool into the housing in a first direction and the at least one surface of the locking member is engageable with the cutting tool to resist movement of the cutting tool in a second direction opposite the first direction, and a released condition, in which the locking member moves against the force of the biasing member and the at least one surface of the locking member is disengageable from the cutting tool.

2. The cutting tool clamp mechanism of claim 1, wherein in response to insertion of the cutting tool through the slot of the locking member, the locking member moves to the engaged condition.

3. The cutting tool clamp mechanism of claim 1, wherein the locking member is configured to pivot within the housing.

4. The cutting tool clamp mechanism of claim 1, wherein the locking member has a first end generally defining a pivot point and a second end opposite of the first end pivotable about the pivot point as the locking member moves between the engaged condition and the released condition.

5. The cutting tool clamp mechanism of claim 1, wherein the at least one surface of the locking member is a planar surface for engaging a planar surface of the cutting tool.

6. The cutting tool clamp mechanism of claim 1, wherein the locking member comprises a plate.

7. The cutting tool clamp mechanism of claim 1, wherein the locking member comprises a plurality of plates arranged in series within the housing, each of the plates including at least one surface engageable with the cutting tool.

8. The cutting tool clamp mechanism of claim 1 and further comprising an actuator for moving the locking member against the force of the biasing member and to the released condition,

9. The cutting tool clamp mechanism of claim 8 wherein a portion of the actuator is positioned outside of the housing.

10. The cutting tool clamp mechanism of claim 8, wherein the actuator is integrally formed with the locking member.

11. The cutting tool clamp mechanism of claim 8, wherein the actuator is movable with respect to the locking member.

12. The cutting tool clamp mechanism of claim 1 and further comprising an ejection system including an ejecting body and an ejecting member configured for biasing the ejecting body against the cutting tool and forcing the cutting tool in the second direction when the locking member is disengaged from the cutting tool.

13. A cutting tool clamp mechanism for a power tool, the cutting tool clamp mechanism comprising:
a housing supported on a spindle, the housing being configured to receive a cutting tool in an insertion pathway and the spindle being configured to drive the cutting tool;
a first slot extending through the housing and being configured to receive the cutting tool, the first slot configured for guiding the cutting tool along the insertion pathway and the first slot defined by at least one surface for engaging the cutting tool when the cutting tool is received by the first slot;
a locking member positioned in and movable with respect to the housing, the locking member including a second slot extending through the locking member for receiving the cutting tool, the second slot defined by at least one surface for engaging the cutting tool when the cutting tool is received by the second slot; and
a biasing member configured for applying a force to the locking member to bias the at least one surface of the locking member into engagement with the cutting tool when the cutting tool is received by the second slot, wherein the at least one surface of the locking member is movable between an engaged condition, in which the at least one surface of the locking member is positioned in the insertion pathway for engaging the cutting tool, and a released condition, in which the at least one surface of the locking member is removed from the insertion pathway for disengaging the cutting tool.

14. The cutting tool clamp mechanism of claim 13, wherein the at least one surface of the locking member and at least one surface of the housing are configured to engage the cutting tool in response to the force of the biasing member against the locking member.

15. The cutting tool clamp mechanism of claim 13, wherein in response to insertion of the cutting tool through the second slot of the locking member, the locking member is configured to move to the engaged position.

16. The cutting tool clamp mechanism of claim 13, wherein the locking member moves against the force of the biasing member to the released condition to disengage the at least one surface of the locking member from the cutting tool.

17. The cutting tool clamp mechanism of claim 13, wherein the locking member is configured to pivot within the housing.

18. The cutting tool clamp mechanism of claim 17, wherein the locking member has a first end generally defining a pivot point and a second end rotatable about the pivot point as the locking member rotates between the engaged condition and the released condition.

19. The cutting tool clamp mechanism of claim 13, wherein the locking member includes at least one locking surface for engaging a portion of the housing to resist axial rotation of the locking member.

20. The cutting tool clamp mechanism of claim 13, wherein the at least one surface of the locking member is a planar surface for engaging a planar surface of the cutting tool.

21. The cutting tool clamp mechanism of claim 13 and further comprising an actuator configured for moving the locking member to the released condition and against the force of the biasing member.

22. The cutting tool clamp mechanism of claim 13 and further comprising an ejection system including an ejecting body and an ejecting member configured for biasing the ejecting body against the cutting tool to eject the cutting tool from the housing when the locking member is in the released condition.

23. A cutting tool clamp mechanism for a power tool, the cutting tool clamp mechanism comprising:
a housing supported on a spindle, the housing being configured to receive a cutting tool in an insertion pathway and the spindle being configured to drive the cutting tool;
a first slot extending through the housing for receiving the cutting tool, the first slot being generally parallel to the pathway for guiding the cutting tool along the pathway;
a locking member positioned in and movable with respect to the housing, the locking member including a second slot extending through the plate for receiving the cutting tool and a surface for engaging the cutting tool when the cutting tool is received by the second slot, wherein the second slot is movable between an engaged condition, in which the second slot is positioned in the pathway and out of alignment with the first slot such that the surface of the locking member is engageable with the cutting tool, and a released condition, in which the second slot is positioned substantially in alignment with the first slot such that the surface of the locking member is disengageable from the cutting tool; and
a biasing member configured for applying a force to the locking member to bias the the locking member to the engaged condition.

24. The cutting tool clamp mechanism of claim 23, wherein the surface of the locking member is configured to engage the cutting tool in response to the force of the biasing member against the locking member.

25. The cutting tool clamp mechanism of claim 23, wherein in response to insertion of the cutting tool through the second slot of the locking member, the locking member is configured to move to the engaged condition.

26. The cutting tool clamp mechanism of claim 23, wherein the locking member is configured for moving to the released condition and against the force of the biasing member.

27. The cutting tool clamp mechanism of claim 23, wherein the locking member includes at least one locking surface for engaging a portion of the housing to resist axial rotation of the locking member.

28. The cutting tool clamp mechanism of claim 27, wherein the locking member has a first end generally defining a pivot point and a second end rotatable about the pivot point as the locking member moves within the housing.

29. The cutting tool clamp mechanism of claim 23, wherein the locking member comprises a plate.

30. The cutting tool clamp mechanism of claim 23 and further comprising an actuator for moving the locking member to the released condition and against the force of the biasing member.

31. The cutting tool clamp mechanism of claim 23 and further comprising an ejection system including an ejecting body and an ejecting member configured for biasing the ejecting body against the cutting tool to eject the cutting tool from the housing when the locking member is in the released condition.
